(19) United States
(12) Patent Application Publication
(10) Pub. No.: US 2023/0298471 A1
(43) Pub. Date: Sep. 21, 2023

(54) AERIAL VEHICLE, DEVICE TO DETERMINE A TARGET LOCATION, STATIC BASE STATION DEVICE AND DOCKING STATION FOR A VEHICLE

(71) Applicant: Intel Corporation, Santa Clara, CA (US)

(72) Inventors: Kedar VISWANATHAN, Bangalore (IN); Maruti TAMRAKAR, Durg (IN); Mythili HEGDE, Bangalore (IN); Ravi DARSI, Balagere (IN)

(21) Appl. No.: 17/975,653

(22) Filed: Oct. 28, 2022

(30) Foreign Application Priority Data
Mar. 21, 2022 (IN) 202241015467

(51) Int. Cl. G08G 5/00; B64C 39/02

(52) U.S. Cl. CPC G08G 5/0008; G08G 5/003; B64C 39/024; B64C 2201/122

(57) ABSTRACT

Various aspects of this disclosure provide an aerial vehicle. The aerial vehicle may include a flight controller configured to control flight components of the aerial vehicle, and a radio access network base station radio head configured to allocate one or more radio resources for one more radio communication terminal devices to operate a radio cell in accordance with a mobile radio wide area network technology.

### CROSS-REFERENCE TO RELATED APPLICATIONS

This non-provision application claims priority to Indian Patent Application 202241015467, which was filed on Mar. 21, 2022, the entire contents of which are incorporated herein.

### TECHNICAL FIELD

Various aspects of this disclosure relate generally to aerial vehicles, a device to determine a target location, a static base station and a docking station for a vehicle.

### BACKGROUND

In New Radio (NR) mmWave, density of radio heads is expected to increase due to smaller mobile radio cell radii. Higher density of small mobile radio cells could mean higher energy consumption of 5G communication networks and inefficient use of radio heads.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an exemplary illustration of a portion of a mobile radio communication network in accordance with various aspects of this disclosure;

FIG. 2 shows an exemplary radio head;

FIG. 3 shows an exemplary aerial vehicle;

FIG. 4 shows an exemplary ground vehicle;

FIG. 5 shows various exemplary electronic components of a safety system of the vehicle in accordance with various aspects of the present disclosure;

FIG. 6 shows an exemplary illustration of a portion of a mobile radio communication network showing various aerial vehicles flying from and to sparse mobile radio cells in accordance with various aspects of this disclosure;

FIG. 7 shows a method to determine a target location for each of a plurality of vehicles in accordance with various aspects of this disclosure;

FIG. 8 shows a flow diagram illustrating a model based learning algorithm to determine a target location for each of a plurality of vehicles in accordance with various aspects of this disclosure;

FIG. 9 shows an exemplary illustration of a portion of a mobile radio communication network in accordance with various aspects of this disclosure during operation;

FIG. 10 shows an exemplary illustration of a portion of a mobile radio communication network in accordance with various aspects of this disclosure during operation;

FIG. 11 shows a docking station in accordance with various aspects of this disclosure.

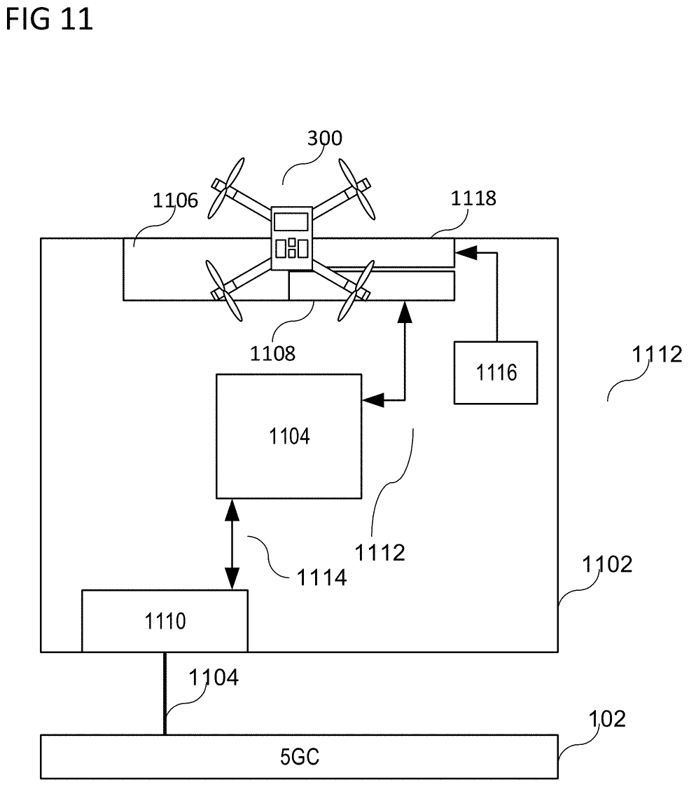

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

As will be described in more detail below, various aspects provide cellular mobile radio heads/repeaters to optimize network performance and energy consumption. Various aspects may optimize small mobile radio cell distribution and energy consumption.

In a conventional radio access network (RAN) solution, a large number of static radio heads is deployed with high expenditure and network planning overhead. Many of these deployed radio heads could be idle most of the time as populations flow in and out of small mobile radio cells. There might also not be a high demand for mm-wave bandwidth communication all the time.

This may result in a higher energy consumption of 5G communication networks and inefficient use of radio heads since most of them could be idle at any given time due to smaller area serviced.

Various aspects of this disclosure propose to have a dedicated network of unmanned vehicles or aerial vehicles which carry or house mobile radio head circuitry. This is provided to allow network algorithms to optimally position the mobile radio heads independent of users' vehicle positions or public vehicle positions. It also gives operators control over maintenance and deployment of radio heads.

Illustratively, various aspects provide unmanned vehicles or aerial vehicles, each equipped with a radio head circuitry and base station functionality. By flexibly controlling the vehicles to fly or drive to specific target locations, the vehicles and their associated mobile radio heads may support in extending or adapting the radio coverage of a mobile radio communication network, e.g. a mmWave mobile radio communication network such as a 5G or 6G or even further future mobile radio communication networks which may use small mobile radio cells. The vehicles having base station functionality can even provide handover services to mobile radio terminal devices.

Radio access network (RAN) radio heads are getting less bulky and the mobile radio cell radii are reducing with the advent of 5G-mmWave mobile radio communication technology. Various aspects deploy sparsely distributed “mobile” radio heads on vehicles such as drones/unmanned vehicles who's on-field positions can be optimized in real-time to provide improved user network experience while improving network planning/deployment and energy expenditure. Moreover, in various aspects, artificial intelligence (AI) based optimization algorithms are provided to dynamically optimize mobile radio head positions (also referred to as target locations in this disclosure) so that radio communication network coverage matches changing radio communication network traffic patterns.

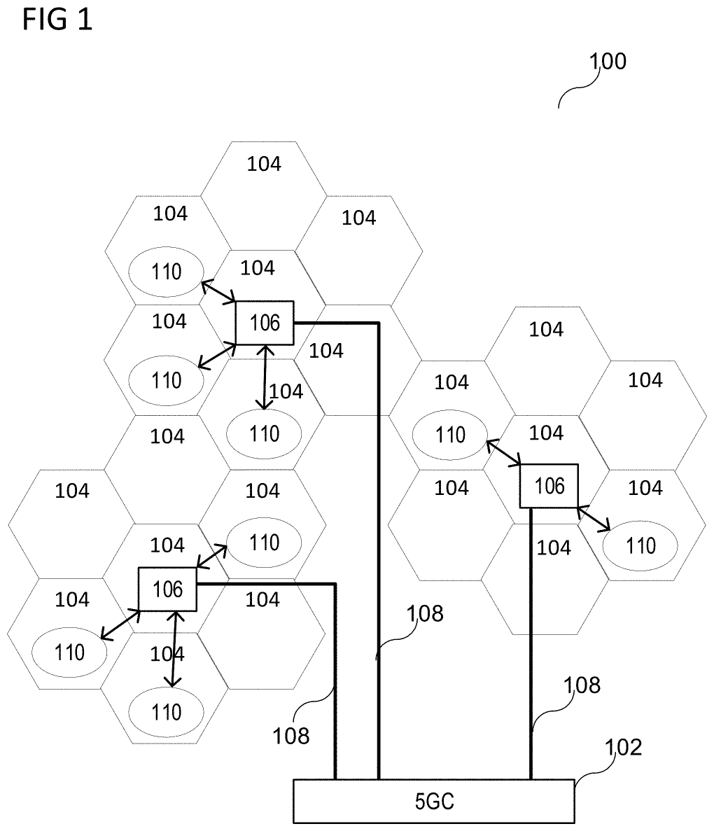

FIG. 1 shows an exemplary illustration of a portion of a mobile radio communication network 100 in accordance with various aspects of this disclosure. The mobile radio communication network 100 and the communication components may be configured in accordance with a mobile radio wide area network technology, e.g. a 5G mobile radio wide area network technology according to 3^{rd} Generation Partnership Project (3GPP) 5G (also referred to as New Radio (NR)). Alternatively or in addition, the mobile radio communication network 100 and the communication components may be configured in accordance with a 4G mobile radio wide area network technology (also referred to as LTE-Advanced). Alternatively or in addition, the mobile radio communication network 100 and the communication components may be configured in accordance with a 6G mobile radio wide area network technology. By way of example, alternatively or in addition, the mobile radio communication network 100 and the communication components may be configured to operate in small mobile radio cells, e.g. in mmWave radio communication technology.

In the example of a 5G mobile radio wide area network technology, communication network 100 may include a core network 102 (also referred to as 5GC 102), which may include one or more of the following components to provide 5G radio communication network services, such as Authentication Server Function (AUSF), Access and Mobility Management Function (AMF), Session Management Function (SMF), User Plane Function (UPF), Network Slice Selection Function (NSSF), Network Exposure Function (NEF), Network Repository Function (NRF), Policy Control Function (PCF), Unified Data Management (UDM), and Application Function (AF) coupled with one another over interfaces (or “reference points”). Functions of the elements of the 5GC 540 may be briefly introduced as follows.

The AUSF may store data for authentication of a terminal device (e.g. User Equipment (UE)) and handle authentication-related functionality. The AMF may allow other functions of the 5GC 102 to communicate with the UE and the RAN and to subscribe to notifications about mobility events with respect to the UE. The AMF may be responsible for registration management (for example, for registering UE), connection management, reachability management, mobility management, lawful interception of AMF-related events, and access authentication and authorization. AMF may also support NAS signaling with the UE over an N3 IWF interface. The SMF may be responsible for SM (for example, session establishment, tunnel management between UPF and access network (AN)); UE IP address allocation and management; selection and control of UP function; configuring traffic steering at UPF to route traffic to proper destination; termination of interfaces toward policy control functions; controlling part of policy enforcement, charging, and Quality of Service (QoS). The UPF may act as an anchor point for intra-RAT and inter-RAT mobility, an external PDU session point of interconnect to data communication network, and a branching point to support multi-homed PDU session. The UPF may also perform packet routing and forwarding, perform packet inspection, enforce the user plane part of policy rules, lawfully intercept packets (UP collection), perform traffic usage reporting, perform QoS handling for a user plane. The NSSF may select a set of network slice instances serving the UE. The NSSF may also determine allowed Network Slice Selection Assistance Information (NSSAI) and the mapping to the subscribed Single-NSSAIs (S-NSSAIs), if needed. The NSSF may also determine the AMF set to be used to serve the UE, or a list of candidate AMFs based on a suitable configuration and possibly by querying the NRF. The selection of a set of network slice instances for the UE may be triggered by the AMF with which the UE is registered by interacting with the NSSF, which may lead to a change of AMF. The NEF may securely expose services and capabilities provided by 3GPP network functions for third party, internal exposure/re-exposure, AFs, edge computing or fog computing systems, etc. The NRF may support service discovery functions, receive NF discovery requests from NF instances, and provide the information of the discovered NF instances to the NF instances. NRF also maintains information of available NF instances and their supported services. The PCF may provide policy rules to control plane functions to enforce them, and may also support unified policy framework to govern network behavior. The UDM may handle subscription-related information to support the network entities' handling of communication sessions, and may store subscription data of UE. The AF may provide application influence on traffic routing, provide access to NEF, and interact with the policy framework for policy control.

Communication network 100 may further include a plurality of mobile radio cells 104. In various examples, mobile radio cells 104 may be so-called small cells (e.g. due to the application of mmWave radio technology). Small cells may be low-powered cellular radio access nodes that operate in licensed and unlicensed spectrum that have a range of 10 meters to a few kilometers. In various aspects, static radio heads 106 (also referred to as static base stations) may operate some of the mobile radio cells 104. Furthermore, communication network 100 may include mobile radio cells 104 without a permanent base station (i.e. without a static radio head 106). Those mobile radio cells 104 may have no radio coverage or only low radio coverage provided by an adjacent mobile radio cell 104 having a static radio head 106 installed and in operation. Communication network 100 may flexibly control vehicles carrying mobile radio heads temporarily to mobile radio cells 104 without a permanent base station (or even to mobile radio cells 104 with a static base station 106) to thereby flexibly extend radio coverage of communication network 100 and/or increase capacity of communication network 100 as desired or required. This will be described in more detail below.

A static radio head or static base station 106 may be connected to the 5GC. Static radio head 106 may be configured as a conventional 5G base station 106 (or a 4G eNodeB, or the like). In various aspects, static radio head 106 may include a communication interface, e.g. an optical interface to connect to an optical fiber 108 to thereby connect to 5GC 102, e.g. to AMF and/or UPF. Static radio head 106 may be connected to an electric grid for power supply. Static radio heads 106 may be placed in small cells 104 with highest consistent radio communication demand. Static radio heads 106 may be located in the center of the small mobile radio cell 104.

A plurality of mobile radio cells 104 may form a cluster, e.g. at least one mobile radio cell 104 of the plurality of mobile radio cells 104 of the cluster provided with a static radio head 106 and the other mobile radio cells 104 of the cluster not provided with a static radio head 106. This configuration is shown in FIG. 1, where e.g. seven hexagonally shaped mobile radio cells 104 form a respective cluster and the center cluster is respectively equipped with a static radio head 106.

As shown in FIG. 1, communication network 100 may further include mobile radio cells 104, in which mobile radio heads 110 (also referred to as mobile base stations 110) are temporarily located. As will be described in more detail below, a vehicle such as an aerial vehicle or a ground vehicle, e.g. an unmanned vehicle, may carry a mobile radio head 110 and may flexibly transport the mobile radio head 110 to a desired target location, e.g. a desired target mobile radio cell 104. In operation, the mobile radio head 110 may connect to an associated static radio head 106, and via the associated static radio head 106 and the corresponding communication interface and e.g. an optical fiber connection, to the 5GC 102. The mobile radio head 110 may be configured to establish a radio communication connection to the associated static radio head 106 according to a radio communication technology, which may be different from the mobile radio wide area network technology used for the communication with the terminal devices. By way of example, mobile radio head 110 may be configured to establish a radio communication connection to the static radio head 106 using at least one of the following technologies: another mobile radio wide area network technology (such as 3G, 4G, 5G, 6G, etc.), a wireless local area network technology (such as IEEE 802.11, 802.11, 802.11a, 802.11b, 802.11be, 802.11g, 802.11n, 802.11p, 802.11-12, 802.11ac, 802.11ad, 802.11ah, etc.), a short range mobile radio technology (such as near-field communication (NFC), Bluetooth, etc.). The mobile radio head 110 may be configured to establish a radio communication connection to the static radio head 106 using a data rate of several GHz, such as 6 GHz or even more. Illustratively, the mobile radio head 110 may use a high data rate technology, e.g. a WLAN technology for communication to the static radio head 106, which illustratively serves as a proxy in this case. Mobile radio heads 110 may e.g. be placed at the edges of a respective cluster as shown in FIG. 1. In addition or as an alternative, mobile radio head 110 may be configured to establish a communication connection to the static radio head 106 using a wireline communication technology.

Illustratively, various aspects provide a distribution of static radio heads 106 and mobile radio heads 110. By way of example, a (e.g. minimum) required mix of static radio heads 106 and mobile radio heads 110/repeaters can be sparsely deployed in a desired region. A communication network fronthaul may be split into static radio heads 106 and mobile radio heads 110. Mobile radio heads 110/repeaters may be placed within 1-2 hops of the static radio heads 106 which may be connected via optical fiber connection to the core network (e.g. 5GC 102) (e.g. to ensure Enhanced Mobile Broadband (eMBB) and Ultra-Reliable Low Latency Communication (URLLC) requirements of 5G).

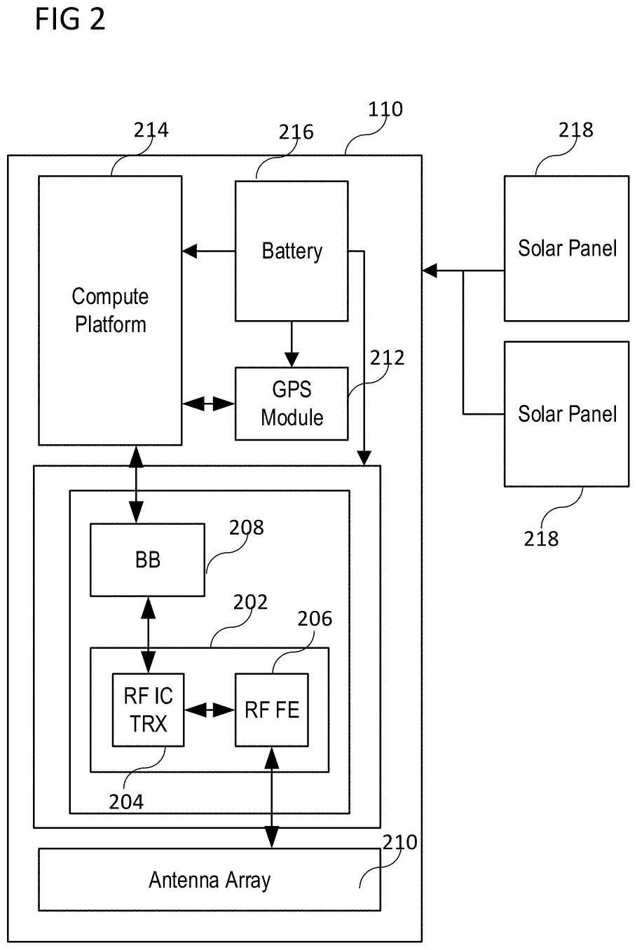

FIG. 2 shows an exemplary mobile radio head 110.

In general, a radio head may be considered as the radio equipment or radio frequency (RF) circuitry for providing an air interface for wireless communication. A radio head includes a wireless transceiver for transmitting and receiving RF signals. For transmission, the radio head may include a converter to convert a digital signal to an RF analog signal and an amplifier to amplify the RF analog signal to a desired power level for radiating the RF signal via an antenna. For reception, the radio head may include an amplifier to amplify an RF analog signal received from an antenna and a converter to convert the RF analog signal to a digital signal. A radio head may be considered as an (integrated) RF transceiver combined with a front-end module (FEM) part that is related to a specific antenna, and includes the least amount of signal processing. An FEM, in general, can include circuitry between a transceiver's (e.g., receiver's) antenna input up to and including the mixer stage. In other words, the FEM may be provided in the Tx path as well as in the Rx path or in both the Tx path and the Rx path.

For example, mobile radio head 110 may include radio head 202. Radio head 202 may include an RF integrated circuit (IC) 204 including one or more RF transceivers (TRX) and a common RF front end (FE) 206. The RF IC 204 may receive one or more data and control signals and operate to receive a communication signal from a baseband IC 208 and generate an RF electrical signal from the communication signal for radio transmission from the mobile radio head 110 or receive an RF electrical signal and generate a communication signal from the RF electrical signal and provide it to the baseband IC 208. The RF FE 206 may convert an RF electrical signal into a format for transmission via one or more antennas 210 (e.g. an antenna array, e.g. AiM/Patch antenna array) and/or convert a signal received from the one or more antennas 210 into an RF electrical signal for the RF IC 204. Radio head 202 and baseband IC 208 may be implemented in a cellular RAN modem, e.g. in QC FSM 200x or any other suitable IC, chip or chipset. Radio head 202 and baseband IC 208 may be configured to operate in accordance with 5G radio communication technology to provide a 5G air interface (RAN) connection to one or more mobile radio terminal devices (such as User Equipment(s) (UE(s))). Moreover, radio head 202 and baseband IC 208 may be configured to provide a (high data rate) air interface connection to an associated static radio head 106, e.g. a WLAN connection as described above.

Mobile radio head 110 may further include a position determination module 212, e.g. a satellite based positioning system, e.g. a Global Navigation Satellite System (GNSS) module, such as e.g. a Global Positioning System (GPS) module or a GLONASS module or a Galileo module or a Beidou module. Position determination module 212 provides position information about the position/location of the mobile radio head 110, e.g. when mounted on a vehicle and moving from or to a mobile radio cell 104.

Furthermore, mobile radio head 110 may include a compute platform 214 to provide digital processing, e.g. to provide handover services and other communication services for mobile radio head 110. Compute platform 214 may implement base station functionality to enable mobile radio head 110 to operate as a base station in accordance with the respectively used (e.g. 5G or 4G) radio communication technology.

Moreover, mobile radio head 110 may include a power supply such as a (e.g. re-chargeable) battery 216. One or more solar panels 218 may be provided to supply energy to the electrical components of the mobile radio head 110 and/or to battery 216.

Mobile radio head 110 may illustratively thus include a radio access network base station radio head configured to allocate one or more radio resources for one more radio communication terminal devices to operate a radio cell in accordance with a mobile radio wide area network technology. In various aspects, mobile radio head 110 may illustratively include a base station radio head configured to provide a base station radio access network communication service by allocating one or more radio channels for one or more radio communication terminal devices in accordance with a mobile radio wide area network technology

A vehicle may carry one or more mobile radio heads 110 to a mobile radio cell 104 and back from the mobile radio cell 104 to a default position or to another position such as another mobile radio cell 104. A vehicle controller may be provided to instruct the vehicle to move to a target location, e.g. indicated by the vehicle controller, or to any other desired or instructed location. The vehicle may be an aerial vehicle (e.g. an unmanned aerial vehicle such as e.g. a drone) or a ground vehicle (e.g. an unmanned ground vehicle such as e.g. an autonomous vehicle such as an unmanned car or a driving robot).

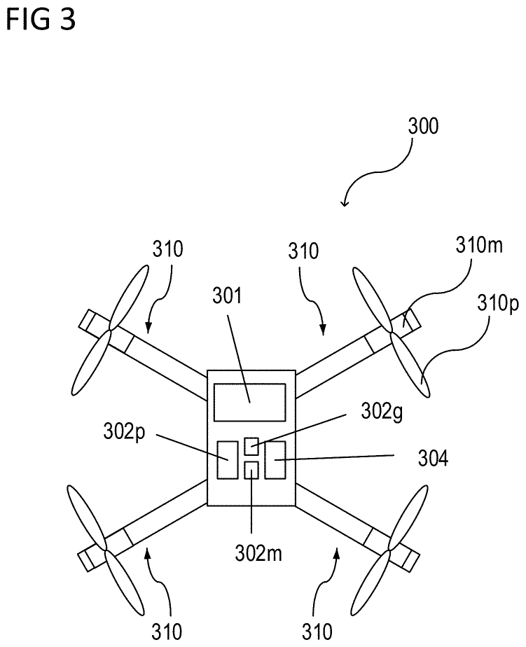

FIG. 3 shows an exemplary unmanned aerial vehicle 300. An unmanned aerial vehicle (UAV) is an aircraft that has the capability of autonomous flight. In autonomous flight, a human pilot is not aboard and in control of the unmanned aerial vehicle. The unmanned aerial vehicle may also be denoted as an unstaffed, uninhabited or unpiloted aerial vehicle, -aircraft or -aircraft system or drone. The unmanned aerial vehicle, according to various aspects, may include a support frame that serves as a basis for mounting components of the unmanned aerial vehicle, such as, for example, motors, sensors, mechanic, transmitter, receiver, and any type of control to control the functions of the unmanned aerial vehicle as desired. One or more of the components mounted to the support frame may be at least partially surrounded by a shell (also referred to as body, hull, outer skin, etc.). As an example, the shell may mechanically protect the one or more components. Further, the shell may be configured to protect the one or more components from moisture, dust, radiation (e.g. heat radiation), etc. In various examples, the unmanned aerial vehicle 300 may include a mobile radio head 110, which may be mounted to the unmanned aerial vehicle 300, e.g. mounted to the support frame of the unmanned aerial vehicle 300.

The unmanned aerial vehicle, according to various aspects, may include a camera gimbal having an independent two- or three-axis degree of freedom to properly track a target, e.g. a person or point of interest, with a tracking camera independently of an actual flight direction or actual attitude of the unmanned aerial vehicle. In some aspects, a depth camera may be used for tracking, monitoring the vicinity, providing images to a user of the unmanned aerial vehicle, etc. A depth camera may allow the association of depth information with an image, e.g., to provide a depth image. This allows, for example, the ability to provide an image of the vicinity of the unmanned aerial vehicle including depth information about one or more objects depicted in the image. The unmanned aerial vehicle, according to various aspects, includes at least one sensor for obstacle detection, e.g. only one sensor, two sensors, or more than two sensors. The at least one sensor can be fixedly mounted on the support frame of the unmanned aerial vehicle. Alternatively, the at least one sensor may be fixed to a movable mounting structure so that the at least one sensor may be aligned into a desired direction.

The unmanned aerial vehicle described herein can be in the shape of an airplane (e.g. a fixed wing airplane) or a copter (e.g. multi rotor copter), i.e. a rotorcraft unmanned aerial vehicle, e.g. a quad-rotor unmanned aerial vehicle, a hex-rotor unmanned aerial vehicle, an octo-rotor unmanned aerial vehicle. The unmanned aerial vehicle described herein may include a plurality of rotors (e.g., three, four, five, six, seven, eight, or more than eight rotors), also referred to as propellers. Each of the propellers has one or more propeller blades. In some aspects, the propellers may be fixed pitch propellers. The unmanned aerial vehicle may be configured to operate with various degrees of autonomy: under remote control by a human operator, or fully or intermittently autonomously, by onboard computers. The unmanned aerial vehicle may be configured to lift-off (also referred to as take-off) and land autonomously in a lift-off and/or a landing operation mode. Alternatively, the unmanned aerial vehicle may be controlled manually by a radio control (RC) at lift-off and/or landing. The unmanned aerial vehicle may be configured to fly autonomously based on a flight path. The flight path may be a predefined flight path, for example, from a starting point or a current position of the unmanned aerial vehicle to a target position, or, the flight path may be variable, e.g., following a target that defines a target position. In some aspects, the unmanned aerial vehicle may switch into a GPS-guided autonomous mode at a safe altitude or safe distance. The unmanned aerial vehicle may have one or more fail-safe operation modes, e.g., returning to the starting point, landing immediately, etc. In some aspects, the unmanned aerial vehicle may be controlled manually, e.g., by a remote control during flight, e.g. temporarily.

FIG. 3 illustrates the unmanned aerial vehicle 300 in a schematic view, according to various aspects. The unmanned aerial vehicle 300 may include a plurality of (e.g., three or more than three, e.g., four, six, eight, etc.) vehicle drive arrangements 310. Each of the vehicle drive arrangements 310 may include at least one drive motor 310m and at least one propeller 310p coupled to the at least one drive motor 310m. According to various aspects, the one or more drive motors 310m of the unmanned aerial vehicle 300 may be electric drive motors. Therefore, each of the vehicle drive arrangements 310 may be also referred to as electric drive or electric vehicle drive arrangement.

Further, the unmanned aerial vehicle 300 may include one or more processors 302p configured to control flight or any other operation of the unmanned aerial vehicle 300. One or more of the processors 302p may be part of a flight controller or may implement a flight controller. The one or more processors 302p may be configured to provide a flight path based at least on a current position of the unmanned aerial vehicle 300 and a received target positon for the unmanned aerial vehicle 300 (e.g. received from a vehicle controller as will be described in more detail below). In some aspects, the one or more processors 302p may control the unmanned aerial vehicle 300 based on a map. In some aspects, the one or more processors 302p may directly control the drive motors 310m of the unmanned aerial vehicle 300, so that in this case no additional motor controller may be used. Alternatively, the one or more processors 302p may control the drive motors 310m of the unmanned aerial vehicle 100 via one or more additional motor controllers. The motor controllers may control a drive power that may be supplied to the respective motor. The one or more processors 302p may include or may implement any type of controller suitable for controlling the desired functions of the unmanned aerial vehicle 300. The one or more processors 302p may be implemented by any kind of one or more logic circuits.

According to various aspects, the unmanned aerial vehicle 300 may include one or more memories 302m. The one or more memories 302m may be implemented by any kind of one or more electronic storing entities, e.g. one or more volatile memories and/or one or more non-volatile memories. The one or more memories 302m may be used, e.g., in interaction with the one or more processors 302p, to build and/or store the map, according to various aspects.

Further, the unmanned aerial vehicle 300 may include one or more power supplies 304. The one or more power supplies 304 may include any suitable type of power supply, e.g., a directed current (DC) power supply. A DC power supply may include one or more batteries (e.g., one or more rechargeable batteries), etc.

The unmanned aerial vehicle 300 may include one or more sensors 301. The one or more sensors 301 may be configured to monitor a vicinity of the unmanned aerial vehicle 300. The one or more sensors 301 may be configured to detect obstacles in the vicinity of the unmanned aerial vehicle 300. According to various aspects, the one or more processors may be further configured to modify a predefined flight path of the unmanned aerial vehicle 300 based on detected obstacles to generate a collision free flight path to the target position avoiding obstacles in the vicinity of the unmanned aerial vehicle. The one or more processors may be further configured to reduce altitude of the unmanned aerial vehicle 300 to avoid a collision during flight, e.g., to prevent a collision with a flying object approaching unmanned aerial vehicle 300 on a collision course. As an example, if the unmanned aerial vehicle 300 and the obstacle may approach each other and the relative bearing remains the same over time, there may be a likelihood of a collision.

The one or more sensors 301 may include, for example, one or more cameras (e.g., a depth camera, a stereo camera, etc.), one or more ultrasonic sensors, one or more radar (radio detection and ranging) sensors, one or more lidar (light detection and ranging) sensors, etc. The one or more sensors 301 may include, for example, any other suitable sensor that allows a detection of an object and the corresponding position of the object. The unmanned aerial vehicle 300 may further include a position detection system 302g. The position detection system 302g may be based, for example, on global positioning system (GPS) or any other available positioning system. Therefore, the one or more processors 302p may be further configured to modify a predefined flight path of the unmanned aerial vehicle 300 based on data obtained from the position detection system 302g. The position detection system 302g may be used, for example, to provide position and/or movement data of the unmanned aerial vehicle 300 itself (including a position, e.g., a direction, a speed, an acceleration, etc., of the unmanned aerial vehicle 300). However, other sensors (e.g., image sensors, a magnetic senor, etc.) may be used to provide position and/or movement data of the unmanned aerial vehicle 300. The position and/or movement data of both the unmanned aerial vehicle 300 and of the one or more obstacles may be used to predict a collision (e.g., to predict an impact of one or more obstacles with the unmanned aerial vehicle).

According to various aspects, the one or more processors 302p may include (or may be communicatively coupled with) at least one transceiver configured to provide an uplink transmission and/or downlink reception of radio signals including data, e.g. video or image data and/or commands. The at least one transceiver may include a radio frequency (RF) transmitter and/or a radio frequency (RF) receiver. By way of example, uplink transmission and/or downlink reception of radio signals may be provided to and/or from a vehicle controller.

The one or more processors 302p may further include (or may be communicatively coupled with) an inertial measurement unit (IMU) and/or a compass unit. The inertial measurement unit may allow, for example, a calibration of the unmanned aerial vehicle 300 regarding a predefined plane in a coordinate system, e.g., to determine the roll and pitch angle of the unmanned aerial vehicle 300 with respect to the gravity vector (e.g. from planet earth). Thus, an orientation of the unmanned aerial vehicle 300 in a coordinate system may be determined. The orientation of the unmanned aerial vehicle 300 may be calibrated using the inertial measurement unit before the unmanned aerial vehicle 300 is operated in flight mode. However, any other suitable function for navigation of the unmanned aerial vehicle 300, e.g., for determining a position, a velocity (also referred to as flight velocity), a direction (also referred to as flight direction), etc., may be implemented in the one or more processors 302p and/or in additional components coupled to the one or more processors 302p. To receive, for example, position information and/or movement data about one or more obstacles, the input of a depth image camera and image processing may be used. Further, to store the respective information in the (e.g., internal) map of the unmanned aerial vehicle 300, as described herein, at least one computing resource may be used.

As already mentioned above, in addition or as an alternative to aerial vehicles, unmanned ground vehicles may also be provided as carriers of the mobile radio heads 110 to transport them to the target locations as determined by the vehicle controller, as will be described in more detail below.

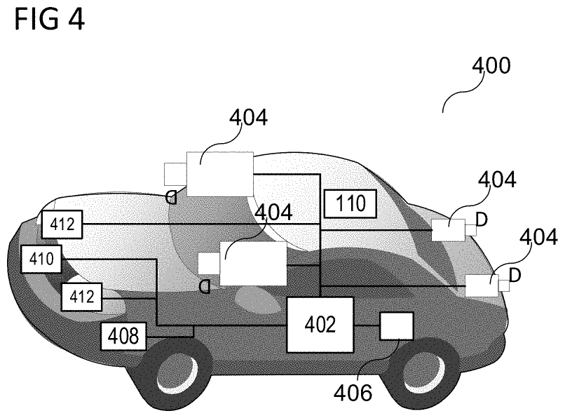

FIG. 4 shows an example of an unmanned ground vehicle such as an unmanned car or an unmanned driving robot. Other examples of an unmanned ground vehicle may include a driven object with a combustion engine, a reaction engine, an electrically driven object, a hybrid driven object, or a combination thereof. An unmanned ground vehicle may be or may include an unmanned automobile, an unmanned bus, an unmanned mini bus, an unmanned van, an unmanned truck, an unmanned mobile home, an unmanned vehicle trailer, an unmanned motorcycle, an unmanned bicycle, an unmanned tricycle, an unmanned moving robot, among others. A ground vehicle may be understood to include any type of vehicle, as described above, which is configured to traverse the ground, e.g., on a street, on a road, on a track, on one or more rails, off-road, etc.

FIG. 4 shows an exemplary ground vehicle, namely ground vehicle 400, in accordance with various aspects of the present disclosure. In some aspects, ground vehicle 400 may include one or more processors 402, one or more image acquisition devices 404, one or more position sensors 406, one or more speed sensors 408, one or more radar sensors 410, and/or one or more LIDAR sensors 412. Furthermore, ground vehicle 400 may include one or more mobile radio heads 110 mounted e.g. to the frame of the ground vehicle 400. The one or more mobile radio heads 110 may be coupled to the one or more processors 402.

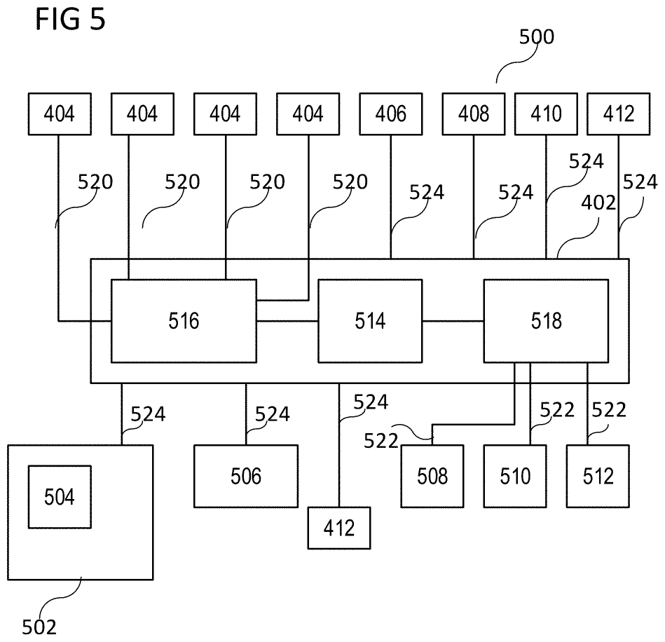

In some aspects, ground vehicle 400 may include a safety system 500 (as described with respect to FIG. 5 below). It is appreciated that ground vehicle 400 and safety system 500 are exemplary in nature and may thus be simplified for explanatory purposes. Locations of elements and relational distances (as discussed above, the figures are not to scale) are provided as examples and are not limited thereto. The safety system 500 may include various components depending on the requirements of a particular implementation.

FIG. 5 shows various exemplary electronic components of the ground vehicle 400, namely safety system 500. The safety system 500 may include one or more processors 402, one or more image acquisition devices 404 (e.g., one or more cameras), one or more position sensors 406 (e.g., a Global Navigation Satellite System (GNSS), a Global Positioning System (GPS), among others) one or more speed sensors 408, one or more radar sensors 410, and/or one or more LIDAR sensors 412. According to at least one aspect, safety system 500 may further include one or more memories 502, one or more map databases 504, one or more user interfaces 506 (e.g., a display, a touch screen, a microphone, a loudspeaker, one or more buttons and/or switches, etc.), and/or one or more wireless transceivers 508, 510, 512. The wireless transceivers 508, 510, 512 may, in some aspects, be configured according to the same, different , or any combination thereof radio communication protocols or standards. By way of example, a wireless transceiver (e.g., a first wireless transceiver 508) may be configured in accordance with a Short Range mobile radio communication standard (e.g., Bluetooth, Zigbee, among others). As another example, a wireless transceiver (e.g., a second wireless transceiver 510) may be configured in accordance with a Medium or Wide Range mobile radio communication standard (e.g., 3G (e.g. Universal Mobile Telecommunications System—UMTS), 4G (e.g. Long Term Evolution—LTE), and/or 5G mobile radio communication standard in accordance with corresponding 3GPP (3rd Generation Partnership Project) standards, among others). As a further example, a wireless transceiver (e.g., a third wireless transceiver 512) may be configured in accordance with a Wireless Local Area Network communication protocol or standard (e.g., IEEE 802.11, 802.11, 802.11a, 802.11b, 802.11g, 802.11n, 802.11p, 802.11-12, 802.11ac, 802.11ad, 802.11ah, among others). The one or more wireless transceivers 508, 510, 512 may be configured to transmit signals via antenna system over an air interface.

In some aspect, the one or more processors 402 may include an application processor 514, an image processor 516, a communication processor 518, and/or any other suitable processing device. Image acquisition device(s) 404 may include any number of image acquisition devices and components depending on the requirements of a particular application. Image acquisition devices 404 may include one or more image capture devices (e.g., cameras, CCDs (charge coupling devices), or any other type of image sensor).

The safety system 500 may also include a data interface communicatively connecting the one or more processors 402 to the one or more image acquisition devices 404. For example, a first data interface may include any wired and/or wireless first link 520 or first links 520 configured to transmit image data acquired by the one or more image acquisition devices 404 to the one or more processors 402 (e.g., to the image processor 516).

The wireless transceivers 508, 510, 512 may, in some aspects, be coupled to the one or more processors 402 (e.g., to the communication processor 518) via, for example a second data interface. The second data interface may include any wired and/or wireless second link 522 or second links 522 configured to transmit radio transmitted data acquired by wireless transceivers 508, 510, 512 to the one or more processors 402, e.g., to the communication processor 518.

In some aspects, the memories 502 as well as the one or more user interfaces 506 may be coupled to each of the one or more processors 402, e.g., via a third data interface. The third data interface may include any wired and/or wireless third link 524 or third links 524. Furthermore, the position sensor 406 may be coupled to each of the one or more processors 402, e.g., via the third data interface.

Such transmissions may also include communications (e.g., one-way or two-way) between the ground vehicle 400 and one or more other (target) vehicles in an environment of the ground vehicle 400 (e.g., to facilitate coordination of navigation of the ground vehicle 400 in view of or together with other (target) vehicles in the environment of the ground vehicle 400), or even a broadcast transmission to unspecified recipients in a vicinity of the transmitting ground vehicle 400.

One or more of the transceivers 508, 510, 512 may be configured to implement one or more vehicle to everything (V2X) communication protocols, which may include vehicle to vehicle (V2V), vehicle to infrastructure (V21), vehicle to network (V2N), vehicle to pedestrian (V2P), vehicle to device (V2D), vehicle to grid (V2G), and other protocols.

Each processor 514, 516, 518 of the one or more processors 402 may include various types of hardware-based processing devices. By way of example, each processor 514, 516, 518 may include a microprocessor, pre-processors (such as an image pre-processor), graphics processors, a central processing unit (CPU), support circuits, digital signal processors, integrated circuits, memory, or any other types of devices suitable for running applications and for image processing and analysis. In some aspects, each processor 514, 516, 518 may include any type of single or multi-core processor, mobile device microcontroller, central processing unit, etc. These processor types may each include multiple processing units with local memory and instruction sets. Such processors may include video inputs for receiving image data from multiple image sensors and may also include video out capabilities.

Any of the processors 514, 516, 518 disclosed herein may be configured to perform certain functions in accordance with program instructions which may be stored in a memory of the one or more memories 502. In other words, a memory of the one or more memories 502 may store software that, when executed by a processor (e.g., by the one or more processors 402), controls the operation of the system, e.g., the safety system. A memory of the one or more memories 502 may store one or more databases and image processing software, as well as a trained system, such as a neural network, or a deep neural network, for example. The one or more memories 502 may include any number of random access memories, read only memories, flash memories, disk drives, optical storage, tape storage, removable storage and other types of storage.

In some aspects, the safety system 500 may further include components such as a speed sensor 408 (e.g., a speedometer) for measuring a speed of the ground vehicle 400. The safety system 500 may also include one or more accelerometers (either single axis or multiaxis) (not shown) for measuring accelerations of the ground vehicle 400 along one or more axes. The safety system 500 may further include additional sensors or different sensor types such as an ultrasonic sensor, a thermal sensor, one or more radar sensors 410, one or more LIDAR sensors 412 (which may be integrated in the head lamps of the ground vehicle 400), and the like. The radar sensors 410 and/or the LIDAR sensors 412 may be configured to provide pre-processed sensor data, such as radar target lists or LIDAR target lists. The third data interface may couple the speed sensor 408, the one or more radar sensors 410 and the one or more LIDAR sensors 412 to at least one of the one or more processors 402.

The one or more memories 502 may store data, e.g., in a database or in any different format, that, e.g., indicate a location of known landmarks. The one or more processors 402 may process sensory information (such as images, radar signals, depth information from LIDAR or stereo processing of two or more images) of the environment of the ground vehicle 400 together with position information, such as a GPS coordinate, a vehicle's ego-motion, etc., to determine a current location of the ground vehicle 400 relative to the known landmarks, and refine the determination of the ground vehicle's location. Certain aspects of this technology may be included in a localization technology such as a mapping and routing model.

The map database 504 may include any type of database storing (digital) map data for the ground vehicle 400, e.g., for the safety system 500. The map database 504 may include data relating to the position, in a reference coordinate system, of various items, including roads, water features, geographic features, businesses, points of interest, restaurants, gas stations, etc. The map database 504 may store not only the locations of such items, but also descriptors relating to those items, including, for example, names associated with any of the stored features. In such aspects, a processor of the one or more processors 402 may download information from the map database 504 over a wired or wireless data connection to a communication network (e.g., over a cellular network and/or the Internet, etc.). In some cases, the map database 504 may store a sparse data model including polynomial representations of certain road features (e.g., lane markings) or target trajectories for the ground vehicle 400. The map database 504 may also include stored representations of various recognized landmarks that may be provided to determine or update a known position of the ground vehicle 400 with respect to a target trajectory. The landmark representations may include data fields such as landmark type, landmark location, among other potential identifiers.

Furthermore, the safety system 500 may include a driving model, e.g., implemented in an advanced driving assistance system (ADAS) and/or a driving assistance and automated driving system. By way of example, the safety system 500 may include (e.g., as part of the driving model) a computer implementation of a formal model such as a safety driving model. A safety driving model may be or include a mathematical model formalizing an interpretation of applicable laws, standards, policies, etc. that are applicable to self-driving (ground) vehicles. A safety driving model may be designed to achieve, e.g., three goals: first, the interpretation of the law should be sound in the sense that it complies with how humans interpret the law; second, the interpretation should lead to a useful driving policy, meaning it will lead to an agile driving policy rather than an overly-defensive driving which inevitably would confuse other human drivers and will block traffic and in turn limit the scalability of system deployment; and third, the interpretation should be efficiently verifiable in the sense that it can be rigorously proven that the self-driving (autonomous) vehicle correctly implements the interpretation of the law. A safety driving model, illustratively, may be or include a mathematical model for safety assurance that enables identification and performance of proper responses to dangerous situations such that self-perpetrated accidents can be avoided.

A safety driving model may implement logic to apply driving behavior rules such as the following five rules:
Do not hit someone from behind.
Do not cut-in recklessly.
Right-of-way is given, not taken.
Be careful of areas with limited visibility.
If you can avoid an accident without causing another one, you must do it.

It is to be noted that these rules are not limiting and not exclusive and can be amended in various aspects as desired. The rules rather represent a social driving contract that might be different depending on the region and may also develop over time. While these five rules are currently applicable in most of the countries they might not be complete and may be amended.

As described above, the ground vehicle 400 may include the safety system 500 as also described with reference to FIG. 5.

The ground vehicle 400 may include the one or more processors 402 e.g. integrated with or separate from an engine control unit (ECU) of the ground vehicle 400.

The safety system 500 may in general generate data to control or assist to control the ECU and/or other components of the ground vehicle 400 to directly or indirectly control the driving of the ground vehicle 400.

The ground vehicle may communicate with the vehicle controller to receive information of the target location (e.g. in a sparse mobile radio cell 104), e.g. coordinates of the target location and instructions to drive to the target location.

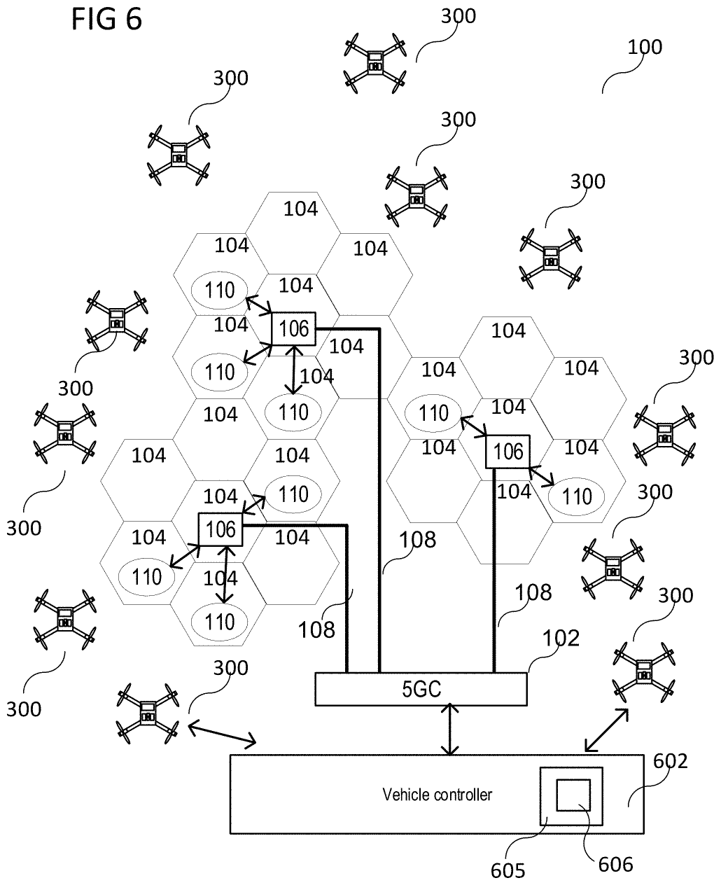

FIG. 6 shows an exemplary illustration of a portion of a mobile radio communication network showing various aerial vehicles 300 (ground vehicles 400 may also be provided but are not shown in FIG. 6) flying from and to (e.g. sparse) mobile radio cells 104 in accordance with various aspects of this disclosure. A vehicle controller 602 is configured to control the aerial vehicles 300 by e.g. transmitting target location information (e.g. coordinates of a target location to which the respective aerial vehicle 300 should fly or an identifier of a target mobile radio cell (as an example of a target location) to which the aerial vehicle 300 should fly and in which the mobile radio head 110 of the aerial vehicle 300 should operate). Having received the target location information via a radio connection 604, the respective aerial vehicle 300 may determine the target location and determine a flight path (also referred to as flight trajectory) from the current location of the aerial vehicle 300 to the determined target location, which may be a predefined location in a mobile radio cell 104. As soon as the aerial vehicle 300 has reached its target location, it may establish a connection (radio or landline) to the 5GC 102 or to a static radio head 106 in an adjacent mobile radio cell 104. Then, if the aerial vehicle 300 has established a respective connection, it may operate as a base station to provide radio access network services to one or more mobile radio communication terminal devices.

The vehicle controller 602 may include a device 605 to determine a target location for each of a plurality of vehicles, e.g. aerial vehicles 300 and/or landline vehicles 400. The device 605 may be part of the vehicle controller 602. As an alternative, the device may be an independent device and located outside the vehicle controller 602, e.g. in the cloud. The device 605 may include one or more processors 606 configured to provide the functions provided to determine the target location for each of a plurality of vehicles.

As described above, each vehicle 300 includes a radio access network radio head configured to allocate one or more radio resources for one more radio communication terminal devices to operate a radio cell in accordance with a mobile radio wide area network technology. The device 605 may include a processor 606 configured to determine a demand for radio communication services at various positions, to determine a target position for each vehicle 300 of a plurality of vehicles 300 based on the determined demand, and to instruct the plurality of vehicles to move to the determined target positions to provide radio communication services in accordance with the mobile radio wide area network technology. By way of example, the processor 606 is configured to determine a target position for each vehicle 300 of the plurality of vehicles 300 using a communication network traffic demand, as will be described in more detail below.

Processor 606 may be configured to perform an artificial intelligence (AI) based smart algorithm for real-time radio head position optimization, in other words, for real-time determination of the target locations of available aerial vehicles 300 carrying respective mobile radio heads 110:
The target locations of these mobile radio heads 110 would be dynamically changed by using optimization algorithms running at the processor 606 (which may also be implemented as a part of a base station controller), e.g. based on real-time network traffic demand/patterns through the day.
The goal of the optimization algorithm may be to direct idle mobile radio heads 110/repeaters towards areas experiencing higher demand or lower signal strength (which requires “boosting”) in the region, e.g. in a respective mobile radio cell 104 or in a cluster of a plurality of mobile radio cells 104.

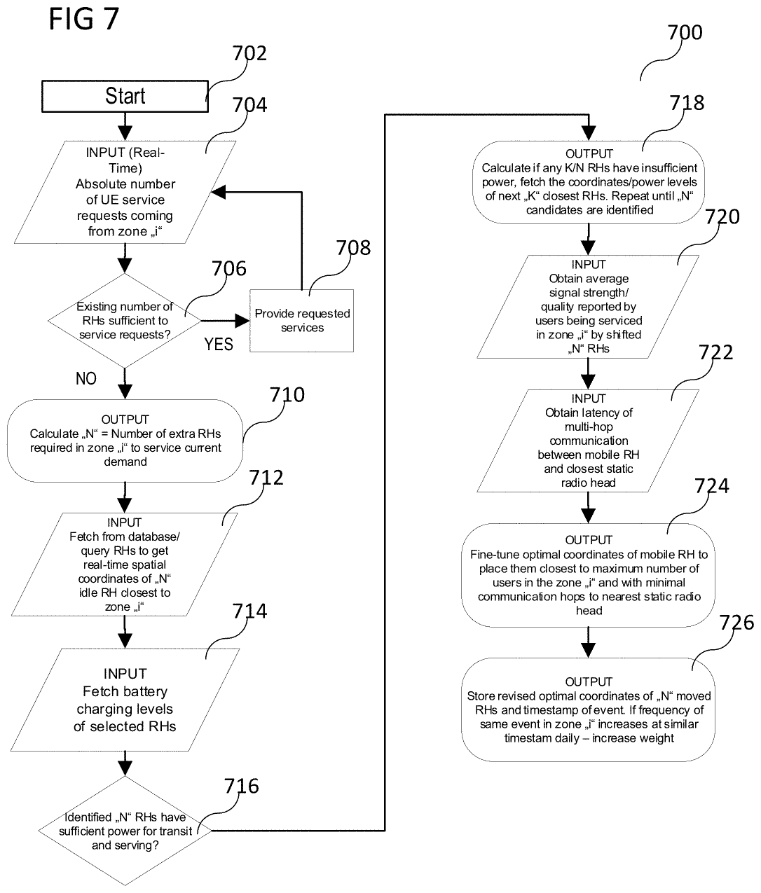

FIG. 7 shows a flowchart of an optimization algorithm (also referred to as method 700 to determine a target location for each 300 of a plurality of vehicles 300) implemented by the processor 106. Assume a “locality” divided into multiple non-intersecting “zones”, e.g. the mobile radio cells 104 or the clusters of a plurality of mobile radio cells 104. Minimum/sparse radio heads (mobile radio heads 110 and static radio heads 106) may be deployed for entire “locality”. For each “zone” (e.g. for each mobile radio cell 104 or for each cluster of mobile radio cells) in “locality” perform the following method.

The method starts in 702. Then, in 704, processor 606 may receive as an input (e.g. in real-time) an absolute number indicating the number of UE service requests coming from zone “i”. In 706, processor 606 may decide whether an existing number of already present radio heads (mobile and static) in zone “i” is sufficient to service the UE service requests coming from zone “i”. If the existing number of already present radio heads (mobile and static) in zone “i” is sufficient (“Yes” in 706), method 700 may continue to provide the requested services for the UEs in zone “i” and stay in the loop of processes 704, 706, 708. As soon as the existing number of already present radio heads (mobile and static) in zone “i” is no longer sufficient (“No” in 706), method 700 may continue to 710 and may include calculating a number N of extra mobile radio heads 110 required in zone “i” to service the current demand, i.e. to serve the UE service requests coming from zone “i”. Processor 606 may determine the N “additional” mobile radio heads 110 for zone “i” by first fetching from a respective database (e.g. by means of a corresponding database query) generally available mobile radio heads 110 (which are e.g. idle, i.e. in RRC (Radio Resource Control) idle state) and the spatial coordinates of their current locations (positions) (in 712). By way of example, processor 606 may query “N” mobile radio heads in RRC idle state from the database which are closest to zone “i” and may then determine the corresponding battery charging levels of the queried “N” mobile radio heads (in 714).

The database may include the following information for each mobile radio head 110 and the associated vehicle 300, 400 carrying the respective mobile radio head 110 which is generally available in the system:
Identification of the mobile radio head 110 and/or the associated vehicle 300, 400;
Current state of the mobile radio head (e.g. current RRC state of the mobile radio head);
Spatial coordinates of the current location (position) of the mobile radio head and/or the associated vehicle 300, 400;
Battery charging level of the associated vehicle 300, 400;

Furthermore, in 716, method 700 may further include determining whether the identified “N” mobile radio heads 110, in particular the associated vehicles 300, 400 have sufficient electrical power to transport (in other words move) the respective mobile radio head 110 to the target location and also then provide the requested mobile radio communication services for the UEs in zone “i”. In 718, processor 606 may determine (e.g. calculate) which mobile radio heads 110 out of the “N” mobile radio heads 110 have insufficient electrical power. Processor 606 may delete those determined mobile radio heads 110 having insufficient electrical power from the list of “N” mobile radio heads 110 and may determine additional mobile radio heads 110 (next) closest to zone “i”. For those additional mobile radio heads 110 and their associated vehicles 300, 400, processor 606 may determine the spatial coordinates of their current locations and their battery charging levels from the database. Method 700 may repeat this deleting and adding of “additional mobile radio heads 110 candidates” until the requested and required “N” mobile radio heads 110 are identified.

Furthermore, method 700 may include, in 720, obtaining an average signal strength or average signal quality reported by the UEs in zone “i” being serviced in zone “i” by shifted (moved by the vehicles 300, 400) “N” mobile radio heads 110 (which the UEs may transmit by means of measurement reports). Then, in 722, method 700 may obtain latency information (e.g. latency values) of multi-hop communication between the involved mobile radio heads 110 and their respectively closest static radio head 106.

Method 700 uses the information gathered in 720 and 722 to fine-tune optimal spatial coordinates (target locations) of the mobile radio heads 110 (and thus the associated vehicles 300, 400) to place them closest (in other words nearest) to a maximum number of UEs in zone “i” and with a minimum number of hops to the closest associated static radio head 106. Processor 606 may output this information as target location information to the determined mobile radio heads 110 (and thus the associated vehicles 300, 400) and may instruct them to move to the respective target location.

Furthermore, processor 606 may store the revised optimal coordinates (as an example of a target location) of the determined “N” moved mobile radio heads 110 and may assign and store a timestamp of that event. If the frequency of same event in zone “i” increases at a similar time instant or time interval (represented by the timestamp) daily, processor 606 may increase a weight value indicating the importance and reliability of the determined target location at the time instant or the time interval.

Processor 606 may implement partial processes 720, 722, 724 using artificial intelligence algorithms. Illustratively, processor 606 may implement a machine learning based network algorithm that “learns” traffic patterns through the day and adapts the overall coverage (radio head positions, in other words target locations for the mobile radio heads 110) accordingly, e.g. in real time.

Thus, various aspects herein may utilize one or more machine learning models to perform or control functions of the vehicle (or other functions described herein), e.g. to determine the target locations of the mobile radio heads 110 over time. The term “model” may, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding desired outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

The model(s) may learn the demand pattern of communication services in the zones (e.g. the mobile radio cells 104 or the clusters of mobile radio cells 104) to thereby provide an optimized set of target locations for the mobile radio heads 110 over the days. Moreover, processor 606 may thus also implement an optimized and adapted handover process scheme for the mobile radio heads 110 and the static radio heads 106, as will be described in more detail below.

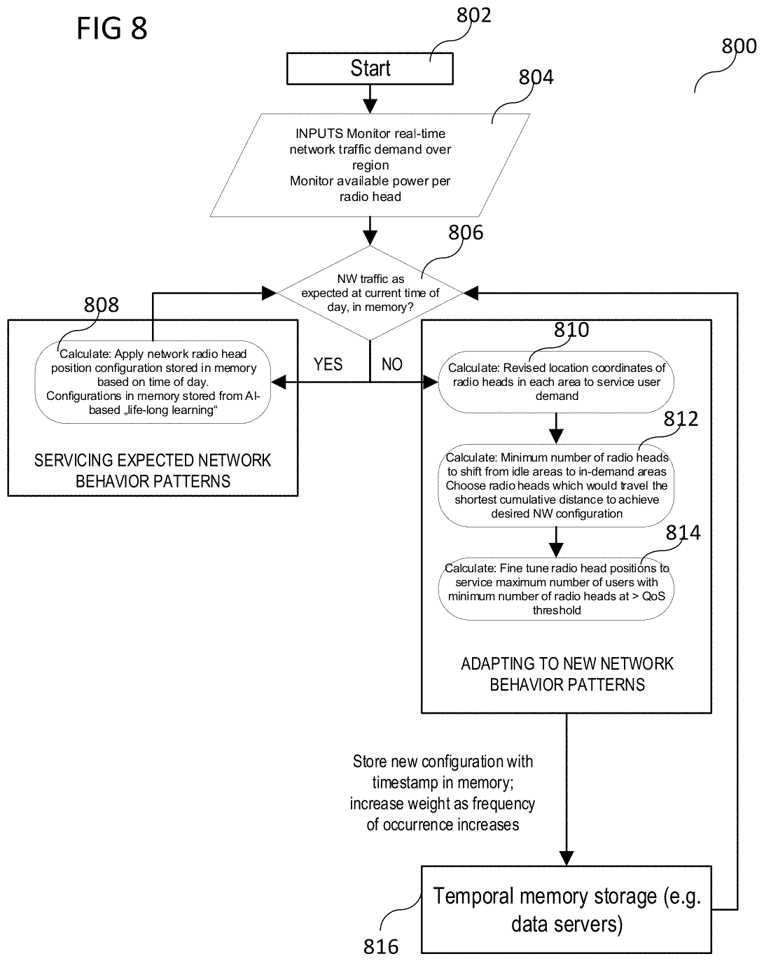

FIG. 8 shows a flow diagram illustrating a model based learning algorithm 800 to determine the target locations for the mobile radio heads 110 over one or more days, one or more weeks or one or more months or even years.

Processor 606 may implement method 800. Method 800 starts in 802 and, in 804, monitors (e.g. in real-time) a network traffic demand over the regions (e.g. the zones as described with reference to FIG. 7 above) as well as available electrical power per mobile radio head and the associated vehicle 300, 400.

Processor 606 may, in 806, determine as to whether the monitored network traffic demand over the regions is as expected at a current time of a day (data representing an expected communication network traffic demand over a day which may be stored in a memory 816 (which may be a temporal memory in one or more data servers)).

In case that the monitored network traffic demand over the regions is as expected at a current time of a day (“Yes” in 806), processor 606 may read network radio head location (position) configuration as stored in the memory 816 and which may be provided by a trained model due to prior (unsupervised or supervised) training (based on time of day, for example), and apply the read network radio head location (position) configuration. Applying the read network radio head location configuration may include determining target locations for the selected mobile radio heads (and the associated vehicles 300, 400) as indicated in the network radio head location (position) configuration stored in the memory 816 and transmitting the target locations together with the instruction to move to the target locations to the target locations to the associated vehicles 300, 400. After having received the target locations and the moving instructions, the selected vehicles 300, 400 will move, e.g. fly or drive, from their current locations to the target locations in accordance with the received moving instructions. Illustratively, the network radio head location configuration is stored in the memory 816 using the AI-based trained model(s), and is continuously or regularly (at specific times) or irregularly (e.g. event driven) updated. Thus, a “life-long learning” of the development of the characteristics of the network traffic demand may be provided (and is “implicitly” stored in the model(s)). Illustratively, process 808 includes a servicing of expected mobile radio communication network behavior patterns. Method 800 may continue in process 806.

In case that the monitored network traffic demand over the regions is not as expected at a current time of a day (“No” in 806), processor 606 may, in 810, calculate revised target location coordinates of mobile radio heads 110 in each area to service user (UE) mobile radio communication demand. Furthermore, in 812, processor 606 may calculate a minimum number of mobile radio heads 110 to move from idle areas to in-demand areas. Processor 606 may select those mobile radio heads 110 (and thus those vehicles 300, 400) which would travel the shortest cumulative distance to achieve the desired network radio head location (position) configuration. Then, in 814, processor 606 may calculate fine tune mobile radio head 110 positions to service a maximum number of UEs with a minimum number of mobile radio head 110 at a quality of service level that is higher than a predefined QoS threshold. Illustratively, processes 810, 812, and 814 may include an adapting of the AI model(s) (using as-such conventional learning or training processes) to new mobile radio communication network behavior patterns. Processor 606 may store the thus determined amended (new) network radio head location (position) configuration (e.g. together with a corresponding time stamp indicating the time instant or time interval the amended network radio head location configuration refers to) in memory 816. Processor 606 may also increase the weight values of the model(s) indicating the importance and reliability of the determined target location at the time instant or time interval with increasing frequency of occurrence. Method 800 may continue in process 806.

The model based “continuous learning” approach may become important to address the challenge of performing handovers as the algorithm would learn the population movement/network traffic movement patterns as a function of time through e.g. the day (or week or month) and increase the weights for more frequently occurring patterns. These learnt patterns (stored in the one or more AI based model(s)) could be used to align mobile radio heads 110 along most accessed travel routes at any given time to facilitate seamless handovers for travelling users and their UEs.

The handling of handovers will now be described in more detail. Mobile Switching Center(s), e.g. located in the 5GC 102 may provide the handover processes and the above described “life-long learning”, i.e. the adapting of the model(s).

In this regard, the following is provided:
Additional challenges are addressed when handling handovers for users (UEs) moving between mobile radio heads 110.
In a conventional solution of static radio heads 106 only, the mobile switching center (MSC) of the 5GC 102 would (upon request from the current static serving base station) search for the location of the next closest static base station (in other words static radio head 106) which would serve the moving user (UE) upon a handover.
However, in the method in accordance with various aspects, the radio heads would also include mobile radio heads 110, and their positions will not be fixed. Hence, the MSC would have an additional function of logging the real-time positions of all the mobile radio heads 110 to orchestrate the handover to the appropriate mobile radio heads 110. The handover could also be done to the fraction of mobile radio cells 104 in the mobile radio communication network which are static, i.e. include static radio heads 106.
In this context, various aspects further take advantage of the AI based smart algorithm (as described above)—which would not just optimize radio head positions in real time. It may also be a “life-long learning” based machine learning algorithm which would store the learnt network traffic patterns in memory 816.

Furthermore, various aspects relate to the power supply for the mobile radio heads 110. There are various approaches to address the power supply for the mobile radio heads 110.
With a significant push towards electric vehicles (vehicles 300, 400 may be electrical vehicles), electric charging stations and related infrastructure is expected to be set up extensively in coming decades. Hence, mobile radio heads 110 can be carried by unmanned ground vehicles 400, which can take advantage of this developing electric charging infrastructure.
However, unmanned aerial vehicles 300 such as drones 300 enjoy the advantage of covering a distance between two points via the shortest distance compared to ground vehicles 400. Hence, solar-powered drones 300 may also be used to carry mobile radio heads 110. They could be in flight only during transit and stationed at their updated positions while servicing users (UEs).

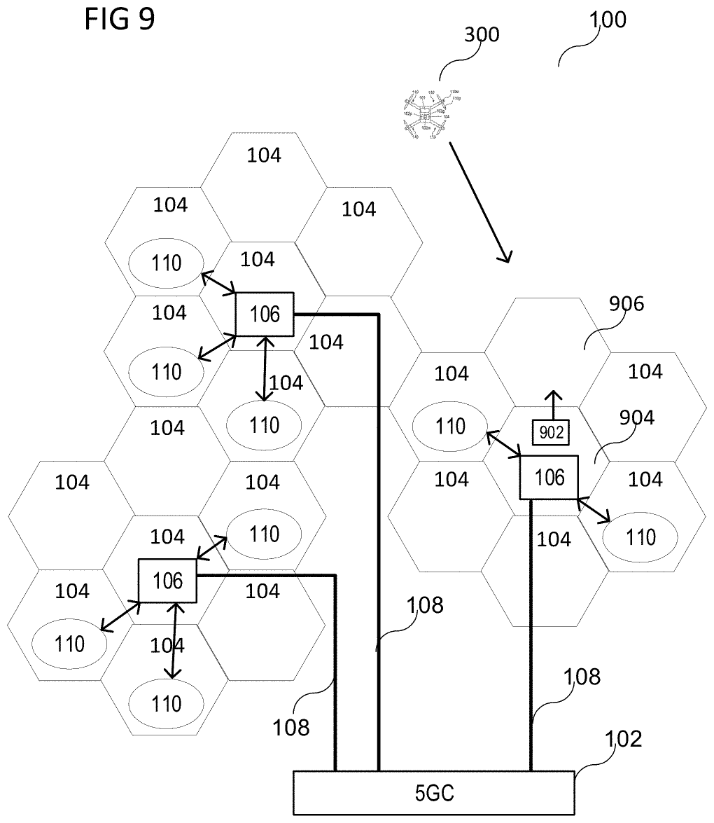

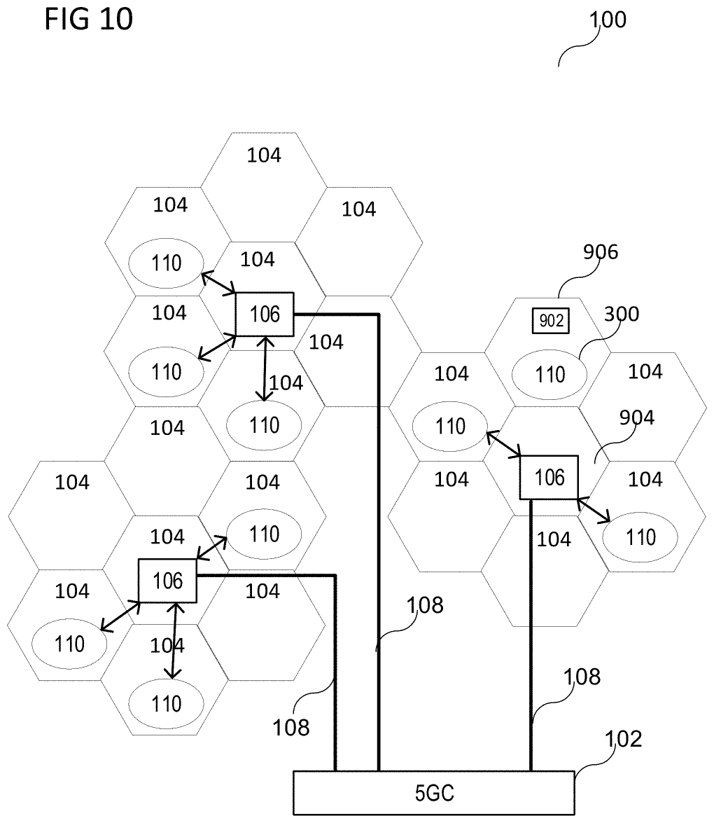

FIG. 9 and FIG. 10 show an exemplary illustration of a portion of the mobile radio communication network 100 in accordance with various aspects of this disclosure during operation. As shown in FIG. 9, it is assumed that one or more UEs 902 may move (in accordance with the AI model(s)) at a specific time instant or time interval from a first mobile radio cell 904 (which in this example is a mobile radio cell with a static radio head 106 (i.e. a static base station) to a second mobile radio cell 906 (which in this example is a mobile radio cell without any radio head (i.e. without a static radio head 106 and without a mobile radio head 110). Thus, when entering the second mobile radio cell 906 and when leaving the radio coverage area of the first mobile radio cell 904, UE 902 would no longer receive radio network coverage and any mobile radio communication connection would be lost. Therefore, processor 606 of vehicle controller 602 may instruct vehicle 300 carrying a mobile radio head 110 to fly to the second mobile radio cell 906 to provide mobile radio coverage therein. After having landed in the second mobile radio cell 906 and after having established a high data rate (backbone) communication connection to the adjacent static radio head 106 and via the same to the 5GC 102 and the MSC therein, mobile radio head 110 in the (now serviced) second mobile radio cell 906 may provide radio access network services to the UE(s) 902 which have newly entered the second mobile radio cell 906 (see FIG. 10). Thus, when entering the second mobile radio cell 906, MSC may perform a handover process for the UE 902 from the static base station 106 of the first mobile radio cell 904 to the mobile radio head 110 (and thus mobile radio base station 110) now operating in the second mobile radio cell 906. Thus, UE 902 keeps the communication connection active.

As described above, the mobile radio cell 110 may be transported by one of the vehicles 300, 400. Vehicles 300, 400 may be electrical vehicles 300, 400. Vehicles 300, 400 may move to the target location and, when arrived at the target location connect to an adjacent static radio head 106 or the 5GC 102, e.g. via a high data rate radio connection, as described above.

Additionally or as an alternative, a docking station 1102 may be provided at a respective target location in a mobile radio cell 104. Docking station 1102 may include a processor 1104, a mechanical connector 1106 to mechanically connect to the vehicle 300, 400, a first communication interface 1108 configured to provide a communication connection between the processor 1104 and the vehicle 300, 400 (e.g. to the mobile radio head 110), and a second communication interface 1110 configured to provide a communication connection 1120 between the processor 1104 and a core network component, e.g. the MSC of the 5GC 102. First communication interface 1108 may be coupled to processor 1104 via a first communication structure (such as one or more communication lines) 1112. Second communication interface 1110 may be coupled to processor 1104 via a second communication structure (such as one or more communication lines) 1114. A power supply 1116 may be provided to provide power to the vehicle 300, e.g. via an energy supply interface 1118 of the docking station 1102. Power supply 1116 may include one or more solar modules to generate power to be provided to the vehicle 300, 400. Second communication interface 1110 may include an optical fiber interface and communication connection 1120 between the processor 1104 and 5GC 102 may include one or more optical fibers 1120.

In various aspects, second communication interface 1110 may be configured to provide (in addition to or as an alternative) a communication interface to another base station such as e.g. a neighbor static radio head 106. Communication interface to another base station may include an Xn interface in accordance with a 3GPP communication standard.

In summary, various aspects may introduce a higher network capability to optimize/reduce energy consumption of cellular communication networks while maximizing performance. Radio communication network planning/deployment costs incurred by mobile radio network operators may be reduced. Radio communication network expansion due to increasing population can also be handled more flexibly with lesser infrastructure costs for mobile radio network operators. Various aspects may create potential to increase average number of users experiencing a good Quality of Service (QoS) at any given time. Further, technically, paradigm of mobile radio heads provides opportunity to employ in cellular radio technology and take advantage of network optimization algorithms developed for resource-starved Wireless Sensor Networks.

In the following, various aspects of this disclosure will be illustrated:

Example 1 is an aerial vehicle. The aerial vehicle may include a flight controller configured to control flight components of the aerial vehicle, and a radio access network base station radio head configured to allocate one or more radio resources for one more radio communication terminal devices to operate a radio cell in accordance with a mobile radio wide area network technology.

In Example 2, the subject matter of Example 1 can optionally include that the radio access network base station radio head is configured to allocate one or more downlink radio resources for one more radio communication terminal devices to operate a radio cell in accordance with the mobile radio wide area network technology.

In Example 3, the subject matter of any one of Examples 1 or 2 can optionally include that the aerial vehicle further includes a handover controller configured to provide a handover process for the one more radio communication terminal devices in accordance with the mobile radio wide area network technology.

In Example 4, the subject matter of any one of Examples 1 to 3 can optionally include that the aerial vehicle further includes a communication circuit configured to provide a radio communication with a static base station in accordance with the mobile radio wide area network technology.

In Example 5, the subject matter of any one of Examples 1 to 4 can optionally include that the aerial vehicle further includes a communication circuit configured to provide a radio communication with a core network in accordance with the mobile radio wide area network technology.

In Example 6, the subject matter of Example 5 can optionally include that the communication circuit is configured to provide a radio communication with the core network via a static base station in accordance with the mobile radio wide area network technology.

In Example 7, the subject matter of any one of Examples 4 or 6 can optionally include that the communication circuit is configured to provide a communication connection with the static base station using a technology which is different from the mobile radio wide area network technology.

In Example 8, the subject matter of Example 7 can optionally include that the communication circuit is configured to provide a communication connection with the static base station using at least one of the following technologies: another mobile radio wide area network technology (such as 3G, 4G, 5G, 6G, etc.), a wireless local area network technology (such as IEEE 102.11a, IEEE 102.11b, etc.), a short range mobile radio technology (such as near-field communication (NFC), Bluetooth, etc.), a wireline communication technology.

In Example 9, the subject matter of any one of Examples 1 to 8 can optionally include that the aerial vehicle further includes a location determiner configured to determine the location of the aerial vehicle.

In Example 10, the subject matter of any one of Examples 1 to 9 can optionally include that the mobile radio wide area network technology is a mmWave mobile radio wide area network technology.

In Example 11, the subject matter of Example 10 can optionally include that the mmWave mobile radio wide area network technology is a 5G mobile radio wide area network technology.

In Example 12, the subject matter of any one of Examples 1 to 11 can optionally include that the aerial vehicle is an unmanned aerial vehicle

In Example 13, the subject matter of any one of Examples 1 to 12 can optionally include that the aerial vehicle further includes a battery to power the flight controller, the flight components, the radio access network radio head and the handover controller.

Example 14 is an aerial vehicle. The aerial vehicle may include a flight controller configured to control flight components of the aerial vehicle, and a base station radio head configured to provide a base station radio access network communication service by allocating one or more radio channels for one or more radio communication terminal devices in accordance with a mobile radio wide area network technology.

In Example 15, the subject matter of Example 14 can optionally include that the radio access network base station radio head is configured to allocate one or more downlink radio channels for one more radio communication terminal devices in accordance with the mobile radio wide area network technology.

In Example 16, the subject matter of any one of Examples 14 or 15 can optionally include that the aerial vehicle further includes a handover controller configured to provide a handover process for the one or more radio communication terminal devices in accordance with the mobile radio wide area network technology.

In Example 17, the subject matter of any one of Examples 14 to 16 can optionally include that the aerial vehicle further includes a communication circuit configured to provide a radio communication with a static base station in accordance with the mobile radio wide area network technology.

In Example 18, the subject matter of any one of Examples 14 to 17 can optionally include that the aerial vehicle further includes a communication circuit configured to provide a radio communication with a core network in accordance with the mobile radio wide area network technology.

In Example 19, the subject matter of Example 18 can optionally include that the communication circuit is configured to provide a radio communication with the core network via a static base station in accordance with the mobile radio wide area network technology.

In Example 20, the subject matter of any one of Examples 17 or 19 can optionally include that the communication circuit is configured to provide a communication connection with the static base station using a technology which is different from the mobile radio wide area network technology.

In Example 21, the subject matter of Example 20 can optionally include that the communication circuit is configured to provide a communication connection with the static base station using at least one of the following technologies: another mobile radio wide area network technology (such as 3G, 4G, 5G, 6G, etc.), a wireless local area network technology (such as IEEE 102.11a, IEEE 102.11b, etc.), a short range mobile radio technology (such as near-field communication (NFC), Bluetooth, etc.), a wireline communication technology.

In Example 22, the subject matter of any one of Examples 14 to 21 can optionally include that the aerial vehicle further includes a location determiner configured to determine the location of the aerial vehicle.

In Example 23, the subject matter of any one of Examples 14 to 22 can optionally include that the mobile radio wide area network technology is a mmWave mobile radio wide area network technology.

In Example 24, the subject matter of Example 23 can optionally include that the mmWave mobile radio wide area network technology is a 5G mobile radio wide area network technology.

In Example 25, the subject matter of any one of Examples 14 to 24 can optionally include that the aerial vehicle is an unmanned aerial vehicle

In Example 26, the subject matter of any one of Examples 14 to 25 can optionally include that the aerial vehicle further includes a battery to power the flight controller, the flight components, the radio access network radio head and the handover controller.

Example 27 is an aerial vehicle. The aerial vehicle may include means for controlling flight components of the aerial vehicle, and means for allocating one or more radio resources for one more radio communication terminal devices to operate a radio cell in accordance with a mobile radio wide area network technology.

Example 28 is an aerial vehicle. The aerial vehicle may include means for controlling flight components of the aerial vehicle, and means for providing a base station radio access network communication service by allocating one or more radio channels for one or more radio communication terminal devices in accordance with a mobile radio wide area network technology.

Example 29 is an unmanned vehicle. The unmanned vehicle may include a controller configured to control vehicle components of the unmanned vehicle, and a radio access network base station radio head configured to allocate one or more radio resources for one more radio communication terminal devices to operate a radio cell in accordance with a mobile radio wide area network technology.

In Example 30, the subject matter of Example 29 can optionally include that the unmanned vehicle is configured as unmanned ground vehicle.

In Example 31, the subject matter of any one of Examples 29 or 30 can optionally include that the radio access network base station radio head is configured to allocate one or more downlink radio resources for one more radio communication terminal devices to operate a radio cell in accordance with the mobile radio wide area network technology.

In Example 32, the subject matter of any one of Examples 29 to 31 can optionally include that the unmanned vehicle further includes a handover controller configured to provide a handover process for the one more radio communication terminal devices in accordance with the mobile radio wide area network technology.

In Example 33, the subject matter of any one of Examples 29 to 32 can optionally include that the unmanned vehicle further includes a communication circuit configured to provide a radio communication with a static base station in accordance with the mobile radio wide area network technology.

In Example 34, the subject matter of any one of Examples 29 to 33 can optionally include that the unmanned vehicle further includes a communication circuit configured to provide a radio communication with a core network in accordance with the mobile radio wide area network technology.

In Example 35, the subject matter of Example 34 can optionally include that the communication circuit is configured to provide a radio communication with the core network via a static base station in accordance with the mobile radio wide area network technology.

In Example 36, the subject matter of any one of Examples 33 or 35 can optionally include that the communication circuit is configured to provide a communication connection with the static base station using a technology, which is different from the mobile radio wide area network technology.

In Example 37, the subject matter of Example 36 can optionally include that the communication circuit is configured to provide a communication connection with the static base station using at least one of the following technologies: another mobile radio wide area network technology (such as 3G, 4G, 5G, 6G, etc.), a wireless local area network technology (such as IEEE 102.11a, IEEE 102.11b, etc.), a short range mobile radio technology (such as near-field communication (NFC), Bluetooth, etc.), a wireline communication technology.

In Example 38, the subject matter of any one of Examples 29 to 37 can optionally include that the unmanned vehicle further includes a location determiner configured to determine the location of the unmanned vehicle.

In Example 39, the subject matter of any one of Examples 29 to 38 can optionally include that the mobile radio wide area network technology is a mmWave mobile radio wide area network technology.

In Example 40, the subject matter of Example 39 can optionally include that the mmWave mobile radio wide area network technology is a 5G mobile radio wide area network technology.

In Example 41, the subject matter of any one of Examples 29 to 40 can optionally include that the unmanned vehicle further includes a battery to power the flight controller, the vehicle components, the radio access network radio head and the handover controller.

Example 42 is an unmanned vehicle. The unmanned vehicle may include a vehicle controller configured to control vehicle components of the unmanned vehicle, and a base station radio head configured to provide a base station radio access network communication service by allocating one or more radio channels for one or more radio communication terminal devices in accordance with a mobile radio wide area network technology.

In Example 43, the subject matter of Example 42 can optionally include that the unmanned vehicle is configured as unmanned ground vehicle.

In Example 44, the subject matter of any one of Examples 42 or 43 can optionally include that the radio access network base station radio head is configured to allocate one or more downlink radio channels for one more radio communication terminal devices in accordance with the mobile radio wide area network technology.

In Example 45, the subject matter of any one of Examples 42 to 44 can optionally include that the unmanned vehicle further includes a handover controller configured to provide a handover process for the one more radio communication terminal devices in accordance with the mobile radio wide area network technology.

In Example 46, the subject matter of any one of Examples 42 to 45 can optionally include that the unmanned vehicle further includes a communication circuit configured to provide a radio communication with a static base station in accordance with the mobile radio wide area network technology.

In Example 47, the subject matter of any one of Examples 42 to 46 can optionally include that the unmanned vehicle further includes a communication circuit configured to provide a radio communication with a core network in accordance with the mobile radio wide area network technology.

In Example 48, the subject matter of Example 47 can optionally include that the communication circuit is configured to provide a radio communication with the core network via a static base station in accordance with the mobile radio wide area network technology.

In Example 49, the subject matter of any one of Examples 46 or 48 can optionally include that the communication circuit is configured to provide a communication connection with the static base station using a technology which is different from the mobile radio wide area network technology.

In Example 50, the subject matter of Example 49 can optionally include that the communication circuit is configured to provide a communication connection with the static base station using at least one of the following technologies: another mobile radio wide area network technology (such as 3G, 4G, 5G, 6G, etc.), a wireless local area network technology (such as IEEE 102.11a, IEEE 102.11b, etc.), a short range mobile radio technology (such as near-field communication (NFC), Bluetooth, etc.), a wireline communication technology.

In Example 51, the subject matter of any one of Examples 42 to 50 can optionally include that the unmanned vehicle further includes a location determiner configured to determine the location of the unmanned vehicle.

In Example 52, the subject matter of any one of Examples 42 to 51 can optionally include that the mobile radio wide area network technology is a mmWave mobile radio wide area network technology.

In Example 53, the subject matter of Example 52 can optionally include that the mmWave mobile radio wide area network technology is a 5G mobile radio wide area network technology.

In Example 54, the subject matter of any one of Examples 42 to 53 can optionally include that the unmanned vehicle further includes a battery to power the flight controller, the flight components, the radio access network radio head and the handover controller.

Example 55 is an unmanned vehicle. The unmanned vehicle may include means for controlling vehicle components of the unmanned vehicle, and means for allocating one or more radio resources for one more radio communication terminal devices to operate a radio cell in accordance with a mobile radio wide area network technology.

Example 56 is an unmanned vehicle. The unmanned vehicle may include means for controlling vehicle components of the unmanned vehicle, and means for providing a base station radio access network communication service by allocating one or more radio channels for one or more radio communication terminal devices in accordance with a mobile radio wide area network technology.

Example 57 is a device to determine a target location for each of a plurality of vehicles. Each vehicle includes a radio access network radio head configured to allocate one or more radio resources for one more radio communication terminal devices to operate a radio cell in accordance with a mobile radio wide area network technology. The device may include a processor configured to determine a demand for radio communication services at various positions, to determine a target position for each vehicle of a plurality of vehicles based on the determined demand, and to instruct the plurality of vehicles to move to the determined target positions to provide radio communication services in accordance with the mobile radio wide area network technology.

In Example 58, the subject matter of Example 57 can optionally include that the processor is configured to determine a target position for each vehicle of the plurality of vehicles using a communication network traffic demand.

In Example 59, the subject matter of any one of Examples 57 or 58 can optionally include that the processor is configured to determine a target position for each vehicle of the plurality of vehicles using a machine learning process.

In Example 60, the subject matter of Example 59 can optionally include that the processor is configured to determine a target position for each vehicle of the plurality of vehicles using one or more neural networks.

In Example 61, the subject matter of any one of Examples 57 to 60 can optionally include that the processor is configured to determine a target position for each vehicle of the plurality of vehicles in real-time.

In Example 62, the subject matter of any one of Examples 57 to 61 can optionally include that the processor is configured to determine a target position for each vehicle of the plurality of vehicles to optimize a function to provide a quality of service as high as possible for a number of terminal devices as high as possible.

In Example 63, the subject matter of any one of Examples 57 to 62 can optionally include that at least some of the vehicles of the plurality of vehicles are aerial vehicles.

In Example 64, the subject matter of Example 63 can optionally include that at least some of the area vehicles are unmanned aerial vehicles.

In Example 65, the subject matter of any one of Examples 57 to 64 can optionally include that the processor is configured to determine as to whether a vehicle of the plurality of vehicles has to be further moved to a further position, and to instruct the vehicle to move to the determined further position.

In Example 66, the subject matter of Example 65 can optionally include that the processor is configured to determine as to whether a vehicle of the plurality of vehicles has to be further moved to a further position using the charging level of a battery of the vehicle.

In Example 67, the subject matter of any one of Examples 65 or 66 can optionally include that the processor is configured to determine as to whether a vehicle of the plurality of vehicles has to be further moved to a further position using a minimum number of hops to a nearest static base station which provides a wireline communication interface to a core network component.

In Example 68, the subject matter of Example 67 can optionally include that the wireline communication interface comprises an optical fiber interface.

In Example 69, the subject matter of any one of Examples 57 to 68 can optionally include that the processor is configured to determine the target position for each vehicle of a plurality of vehicles taking into consideration positions of one or more static base stations to which the vehicles should communicate.

In Example 70, the subject matter of Example 69 can optionally include that the processor is configured to determine the target position for each vehicle of a plurality of vehicles taking into consideration the distances between the vehicles and the positions of one or more static base stations to which the vehicles should communicate.

In Example 71, the subject matter of Example 70 can optionally include that the processor is configured to determine target position for each vehicle of a plurality of vehicles taking into consideration the distances between the vehicles and the positions of one or more static base stations to which the vehicles should communicate.

In Example 72, the subject matter of any one of Examples 57 to 70 can optionally include that the mobile radio wide area network technology is a mmWave mobile radio wide area network technology.

In Example 73, the subject matter of Example 72 can optionally include that the mmWave mobile radio wide area network technology is a 5G mobile radio wide area network technology.

In Example 74, the subject matter of any one of Examples 57 to 73 can optionally include that the aerial vehicle is an unmanned aerial vehicle

Example 75 is a device to determine a target location for each of a plurality of vehicles. Each vehicle includes a radio access network radio head configured to allocate one or more radio resources for one more radio communication terminal devices to operate a radio cell in accordance with a mobile radio wide area network technology. The device may include means for determining a demand for radio communication services at various positions, means for determining a target position for each vehicle of a plurality of vehicles based on the determined demand, and means for instructing the plurality of vehicles to move to the determined target positions to provide radio communication services in accordance with the mobile radio wide area network technology.

Example 76 is a static base station device. The static base station device may include a radio access network radio head configured to provide a radio communication service with one or more radio communication terminal devices in accordance with a mobile radio wide area network technology, and a communication circuit configured to provide a communication connection with a mobile base station in an aerial vehicle using a technology which is different from the mobile radio wide area network technology.

In Example 77, the subject matter of Example 76 can optionally include that the static base station device further includes a handover controller configured to provide a handover process for the one more radio communication terminal devices in accordance with the mobile radio wide area network technology.

In Example 78, the subject matter of any one of Examples 76 or 77 can optionally include that the communication circuit is configured to provide a communication connection with the static base station using at least one of the following technologies: another mobile radio wide area network technology (such as 3G, 4G, 5G, 6G, etc.), a wireless local area network technology (such as IEEE 102.11a, IEEE 102.11b, etc.), a short range mobile radio technology (such as near-field communication (NFC), Bluetooth, etc.), a wireline communication technology.

In Example 79, the subject matter of any one of Examples 76 to 78 can optionally include that the mobile radio wide area network technology is a mmWave mobile radio wide area network technology.

In Example 80, the subject matter of Example 79 can optionally include that the mmWave mobile radio wide area network technology is a 5G mobile radio wide area network technology.

In Example 81, the subject matter of any one of Examples 76 to 80 can optionally include that the aerial vehicle is an unmanned aerial vehicle

Example 82 is a docking station for a vehicle of any one of Examples 1 to 56. The docking station may include a processor, a mechanical connector to mechanically connect to the vehicle, a first communication interface configured to provide a communication connection between the processor and the vehicle, and a second communication interface configured to provide a communication connection between the processor and a core network component.

In Example 83, the subject matter of Example 82 can optionally include that the docking station further includes a power supply configured to provide power to the vehicle.

In Example 84, the subject matter of Example 83 can optionally include that the power supply comprises one or more solar modules to generate power to be provided to the vehicle.

In Example 85, the subject matter of any one of Examples 82 to 84 can optionally include that the second communication interface comprises an optical fiber interface.

In Example 86, the subject matter of any one of Examples 82 to 85 can optionally include that the second communication interface is configured to provide a communication interface to another base station.

In Example 87, the subject matter of Example 86 can optionally include that the communication interface to another base station includes an Xn interface in accordance with a 3GPP communication standard.

Example 88 is a system. The system may include a plurality of vehicles of any one of Examples 1 to 56, and a device of any one of Examples 57 to 75.

In Example 89, the subject matter of Example 88 can optionally include that the system further includes one or more static base stations of any one of Examples 76 to 81.

In Example 90, the subject matter of any one of Examples 88 or 89 can optionally include that the system further includes a docking station of any one of Examples 82 to 87.

The terms “processor” or “controller” as, for example, used herein may be understood as any kind of entity that allows handling data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” detailed herein may be understood to include any suitable type of memory or memory device, e.g., a hard disk drive (HDD), a solid-state drive (SSD), a flash memory, etc.

Differences between software and hardware implemented data handling may blur. A processor, controller, and/or circuit detailed herein may be implemented in software, hardware and/or as hybrid implementation including software and hardware.

The term “system” (e.g., a sensor system, a control system, a computing system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

The term “position” used with regard to a “position of an unmanned aerial vehicle”, “position of an object”, “position of an obstacle”, and the like, may be used herein to mean a point or region in a two- or three-dimensional space. It is understood that suitable coordinate systems with respective reference points are used to describe positions, vectors, movements, and the like. The term “flight path” used with regard to a “predefined flight path”, a “traveled flight path”, a “remaining flight path”, and the like, may be understood as a trajectory in a two- or three-dimensional space. The flight path may include a series (e.g., a time-resolved series) of positions along which the unmanned aerial vehicle has traveled, a respective current position, and/or at least one target position towards which the unmanned aerial vehicle is traveling. The series of positions along which the unmanned aerial vehicle has traveled may define a traveled flight path. The current position and the at least one target position may define a remaining flight path.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An aerial vehicle, comprising:
a flight controller configured to control flight components of the aerial vehicle; and
a radio access network base station radio head configured to allocate one or more radio resources for one more radio communication terminal devices to operate a radio cell in accordance with a mobile radio wide area network technology.

2. The aerial vehicle of claim 1, further comprising:
a handover controller configured to provide a handover process for the one more radio communication terminal devices in accordance with the mobile radio wide area network technology.

3. The aerial vehicle of claim 1, further comprising:
a communication circuit configured to provide a radio communication with a static base station in accordance with the mobile radio wide area network technology.

4. The aerial vehicle of claim 1, further comprising:
a communication circuit configured to provide a radio communication with a core network in accordance with the mobile radio wide area network technology.

5. The aerial vehicle of claim 1,
wherein the aerial vehicle is an unmanned aerial vehicle

6. An unmanned vehicle, comprising:
a controller configured to control vehicle components of the unmanned vehicle; and
a radio access network base station radio head configured to allocate one or more radio resources for one more radio communication terminal devices to operate a radio cell in accordance with a mobile radio wide area network technology.

7. The unmanned vehicle of claim 6,
wherein the unmanned vehicle is configured as unmanned ground vehicle.

8. The unmanned vehicle of claim 6, further comprising:
a handover controller configured to provide a handover process for the one more radio communication terminal devices in accordance with the mobile radio wide area network technology.

9. The unmanned vehicle of claim 6, further comprising:
a communication circuit configured to provide a radio communication with a static base station in accordance with the mobile radio wide area network technology.

10. A device to determine a target location for each of a plurality of vehicles, each vehicle comprising a radio access network radio head configured to allocate one or more radio resources for one more radio communication terminal devices to operate a radio cell in accordance with a mobile radio wide area network technology;
the device comprising a processor configured to:
determine a demand for radio communication services at various positions;
determine a target position for each vehicle of a plurality of vehicles based on the determined demand;
instruct the plurality of vehicles to move to the determined target positions to provide radio communication services in accordance with the mobile radio wide area network technology.

11. The device of claim 10,
wherein the processor is configured to determine a target position for each vehicle of the plurality of vehicles using a communication network traffic demand.

12. The device of claim 10,
wherein the processor is configured to determine a target position for each vehicle of the plurality of vehicles using a machine learning process.

13. The device of claim 10,
wherein the processor is configured to determine a target position for each vehicle of the plurality of vehicles in real-time.

14. The device of claim 10,
wherein at least some of the vehicles of the plurality of vehicles are aerial vehicles.

15. The device of claim 14,
wherein the processor is configured to:
determine as to whether a vehicle of the plurality of vehicles has to be further moved to a further position;
instruct the vehicle to move to the determined further position.

16. The device of claim 10,
wherein the processor is configured to determine as to whether a vehicle of the plurality of vehicles has to be further moved to a further position using the charging level of a battery of the vehicle.

17. The device of claim 10,
wherein the processor is configured to determine the target position for each vehicle of a plurality of vehicles taking into consideration the distances between the vehicles and the positions of one or more static base stations to which the vehicles should communicate.

18. A static base station device comprising:
a radio access network radio head configured to provide a radio communication service with one or more radio communication terminal devices in accordance with a mobile radio wide area network technology;
a communication circuit configured to provide a communication connection with a mobile base station in an aerial vehicle using a technology which is different from the mobile radio wide area network technology.

19. The static base station device of claim 18, further comprising:
a handover controller configured to provide a handover process for the one more radio communication terminal devices in accordance with the mobile radio wide area network technology.

20. The static base station device of claim 18, wherein the static base station device further comprises a handover controller configured to provide a handover process for the one more radio communication terminal devices in accordance with the mobile radio wide area network technology.
